(19) United States
(12) Patent Application Publication
(10) Pub. No.: US 2016/0091468 A1
(43) Pub. Date: Mar. 31, 2016

(54) METHOD FOR MEASURING RELATIVE CONTENT OF GRAM-NEGATIVE BACTERIA IN ACTIVE SLUDGE

(71) Applicant: Nanjing University, Nanjing (CN)

(72) Inventors: Hongqiang REN, Nanjing (CN); Wenbo SU, Nanjing (CN); Lili DING, Nanjing (CN); Jinjv GENG, Nanjing (CN); Ke XU, Nanjing (CN); Yan ZHANG, Nanjing (CN)

(21) Appl. No.: 14/852,621

(22) Filed: Sep. 13, 2015

(30) Foreign Application Priority Data
Sep. 30, 2014 (CN) 201410522929.0

(51) Int. Cl. G01N 30/74

(52) U.S. Cl. CPC G01N 30/74

(57) ABSTRACT

A method for measuring a relative content of Gram-negative bacteria in an active sludge, the method including: 1) breaking zoogloeas in the active sludge; 2) isolating 2-keto-3-deoxyoctonic acid (KDO) from free bacteria and cell debris; 3) performing fluorescence labeling on the isolated KDO to obtain a fluorescent derivative; and 4) isolating the fluorescent derivative by high performance liquid chromatography (HPLC) and conducting quantitative measurement by fluorescence to obtain the relative content of the Gram-negative bacteria in the active sludge.

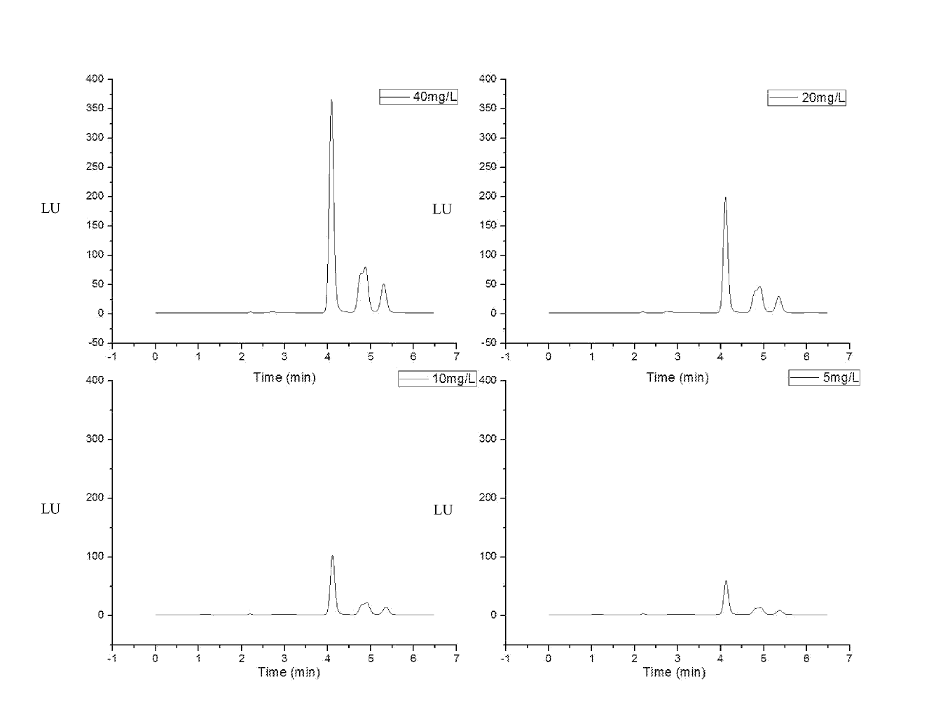

### CROSS-REFERENCE TO RELATED APPLICATIONS

Pursuant to 35 U.S.C. §119 and the Paris Convention Treaty, this application claims the benefit of Chinese Patent Application No. 201410522929.0 filed Sep. 30, 2014, the contents of which are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND OF THE INVENTION

1. Field of the Invention

The invention relates to a method for measuring a relative content of Gram-negative bacteria in an active sludge.

2. Description of the Related Art

A typical method for analyzing contents of different microbes in the active sludge is the PCR technology. However, the results have poor repeatability due to the different DNA extraction efficiency; the cell lysis degree of the prokaryote cells is different, so that the abundance estimation of cells difficult to destruct is relatively low; and the amplification efficiency of the primer in different samples is different, thereby resulting in error in the abundance estimation of the communities.

### SUMMARY OF THE INVENTION

In view of the above-described problems, it is one objective of the invention to provide a method for measuring a relative content of Gram-negative bacteria in an active sludge. The method is able to fast measure the relative content of the dominant bacteria in the active sludge and to accurately know the relative structure of the microbial community.

To achieve the above objective, in accordance with one embodiment of the invention, there is provided a method for measuring a relative content of Gram-negative bacteria in an active sludge. The method comprises:

1) breaking zoogloeas in the active sludge by homogenization;

2) isolating KDO from free bacteria and a cell debris in acid condition;

3) performing fluorescence labeling on the isolated KDO whereby obtaining a fluorescent derivative, and keeping the fluorescent derivative in dark; and

4) isolating the fluorescent derivative by high performance liquid chromatography (HPLC) and conducting quantitative measurement by fluorescence, whereby obtaining the relative content of the Gram-negative bacteria in the active sludge.

In a class of this embodiment, breaking zoogloeas in the active sludge means that the agglomerated bacteria are broken by homogenization into free bacteria or even into the cell debris, so as to simplify the subsequent KDO isolating process and to shorten the reaction time.

In a class of this embodiment, isolating KDO from the free bacteria or the cell debris means that a strong acid is added to the broken sludge and a resulting mixture is heated. Thus, LPS attached to the cell membrane is isolated to form free LPS, and the KDO molecular in LPS are totally separated out, thereby ensuring that the subsequent derivation reaction is complete and the fluorescent quantification is accurate.

In a class of this embodiment, performing fluorescence labeling on the isolated KDO means that a proper amount of a fluorescent labeling substance and a corresponding stabilizer are added to the active sludge liquid after acidification to enable the isolated free KDO to react with the fluorescent labeling substance, whereby producing a corresponding derivative product.

In a class of this embodiment, the relative content of the Gram-negative bacteria is calculated by the following equation:

$$Relative content of Gram - negative bacteria ( µg \text{/} mg ) = \frac{KDO ( µg \text{/} L )}{MLSS ( mg \text{/} L )}$$

in which, KDO represents the content of 2-keto-3-deoxyoctonic acid in different sludge samples measured by the HPLC, and MLSS represents a content of mixed liquor suspended solids.

Advantages of the method for measuring a relative content of Gram-negative bacteria according to embodiments of the invention are summarized as follows:

1. The method of the invention is adapted to analyze the relative content of the Gram-negative bacteria of active sludge samples collected from different process stages. The method of the invention features simple operation and low cost and is applicable to general laboratory practice.

2. The method of the invention is able to calculate the relative content of the Gram-negative bacteria based on the KDO content in the active sludge in the absence of pure cultivation, thereby avoiding the error that is resulted from the selectivity of the bacteria to the culture medium during classification and calculation of the Gram-negative bacteria by the conventional culture staining method.

3. The related molecular biological techniques based on the PCR amplification are avoided to be utilized in analyzing the relative content of the Gram-negative bacteria, so that errors resulted from the specificity or non-specificity of the primers, the amplification efficiency, and the inherent bias of PCR during the PCR process are avoided.

### BRIEF DESCRIPTION OF THE DRAWINGS

The invention is described hereinbelow with reference to accompanying drawings, in which the sole figure is HPLC chromatograms of standard substances of KDO in accordance with one embodiment of the invention.

### DETAILED DESCRIPTION OF THE EMBODIMENTS

For further illustrating the invention, experiments detailing a method for measuring a relative content of Gram-negative bacteria in an active sludge are described below. It should be noted that the following examples are intended to describe and not to limit the invention.

Analysis of relative contents of Gram-negative bacteria was conducted on an active sludge from an aeration tank of a sewage treatment plant. The active sludge samples were collected respectively from aeration tanks of three municipal sewage treatment plants in Nanjing and were labeled as sample A, sample B, and sample C. The experiment was carried out as follows:

1) Destruction of zoogloeas and free bacteria in the sludge by homogenization

A. 200 mL of each sample in the form of a sludge-water mixture was added to a high pressure homogenizer;

B. Parameters of the high pressure homogenizer were as follows: the homogenization was conducted at a homogenization pressure of 20 megapascal for twice, with each time lasting for 30 s.

2) Acidification of free bacteria and cell debris by strong acid for isolating KDO

A. 200 μL of the sludge after treated by high pressure homogenization and 800 μL of HCl (0.025N) were subsequently added to a first sample bottle, and the bottle sample was then sealed.

B. The sample bottle was placed in a water bath at a temperature of 80° C. and heated for 1 hr for carrying out reaction. A resulting mixture was thereafter cooled by ice water to the room temperature.

3) Production of fluorescent derivative by fluorescent substance and KOD

A. The active sludge after acidification was filtered by a filter membrane having a pore size of 0.22 μm, and 200 μL of a filtrate was then injected to a second sample bottle.

B. 200 μL of a 4,5-methylenedioxy-1,2-phenylenediamine dihydrochloride (MDB) solution having a concentration of 7 mM was added to the second sample bottle, and then the second bottle was sealed.

C. The second sample bottle was placed in the water bath at a temperature of 60° C. and heated for 3 hrs for carrying out reaction, and the second bottle was then treated with ice water to decrease the temperature of a resulting mixture to the room temperature.

4) Quantitative analysis of KDO content in the sample by reversed-phase high performance liquid chromatography (RP-HPLC)

A. Requirements for operating the RP-HPLC for analysis of KDO in the sample were as follows:

Chromatographic column: C₁₈, 5 μm, 250×4.6 mm (I.D)

Volume ratio of constituents of a mobile phase: methanol: acetonitrile: water=210:90:700

Flow rate: 1.0 ml/min

Column temperature: 30° C.

Wavelength of fluorescent excitation ray: 367 nm

Wavelength of fluorescent emission ray: 446 nm

Injection volume: 10 μL

B. Standard curves were charted as shown in the figure according to the HPLC chromatograms of standard substances of the KDO. The concentration of KDO in the sample was calculated according to the peak area corresponding to a conspecific retaining time of the sample, concentrations of KDO of active sludge from three aeration tanks and the relative contents of the Gram-negative bacteria were listed in Table 1.

TABLE 1
Concentrations of KDO of three samples

| | KDO | MLSS | Relative content of Gram- |
|---|---|---|---|
| Sample | (μg/L) | (mg/L) | negative bacteria (μg/mg) |
| A | 245.3 | 4420 | 0.56 |
| B | 60.8 | 3350 | 0.18 |
| C | 402.7 | 3560 | 1.13 |

In order to testify the results of the invention, the same samples were also performed with the phospholipid fatty acid (PLFA) spectrum technology to analyze the relative content of the Gram-negative bacteria. Since different microbial populations feature different characteristic fatty acid, the structure of the microbial community can be represented by the relative content of the characteristic fatty acid. It has been known from reports that multiple branched chain fatty acids can represent the Gram-positive bacteria, while monounsaturated fatty acid and cyclopropane fatty acids can indicate the Gram-negative bacteria.

According to the corresponding method, PLFA in the three active sludge samples were analyzed and results thereof were shown in Table 2.

TABLE 2
Distribution of total PLFA in three active sludge samples

| Analyte | A | B | C |
|---|---|---|---|
| C11:0 iso | ND | ND | 0.52 |
| C12:0 | 5.14 | 4.24 | 3.05 |
| C13:0 iso | 0.18 | ND | ND |
| C13:0 anteiso | ND | 0.15 | ND |
| C14:0 iso | 1.56 | 4.92 | 3.10 |
| C14:0 w5c | ND | ND | 0.17 |
| C14:0 | 1.29 | 1.07 | 1.08 |
| C15:1 iso G | 0.45 | 0.22 | 0.28 |
| C15:1 anteiso A | 0.47 | 1.67 | 2.07 |
| C15:0 iso | 1.34 | 1.10 | 1.17 |
| C15:0 anteiso | 5.23 | 24.39 | 20.35 |
| C16:0 iso | 1.97 | 6.95 | 5.98 |
| C16:1 w7c | 1.64 | 0.94 | 1.79 |
| C16:1 w5c | 0.14 | ND | 0.17 |
| C16:0 | 39.37 | 26.67 | 29.82 |
| C16:0 2OH | 0.18 | ND | ND |
| C17:1 iso w9c | 0.32 | 0.15 | 0.48 |
| C17:1 iso w5c | 0.41 | 0.18 | ND |
| C17:1 anteiso | ND | ND | 0.16 |
| C17:0 iso | 0.32 | 0.33 | 0.40 |
| C17:0 anteiso | 0.69 | 1.01 | 1.33 |
| C17:1 w8c | 0.25 | ND | 0.18 |
| C17:0 cyclo | ND | ND | 0.29 |
| C17:0 | 0.85 | 1.26 | 1.32 |
| C17:0 iso 3OH | 0.40 | 0.18 | 0.26 |
| C17:0 2OH | ND | 0.20 | ND |
| C17:0 3OH | 0.45 | ND | ND |
| C18:iso | 0.31 | 0.36 | 0.48 |
| C18:2 w6, 9c | 0.37 | ND | ND |
| C18:1 w9c | 1.14 | 1.07 | 1.13 |
| C18:1 w7c 11-methyl | 0.17 | 0.15 | 0.15 |
| C18:1 w7c | 3.33 | 0.57 | 1.10 |
| C18:0 | 30.56 | 21.94 | 21.67 |
| C18:1 w5c | ND | ND | 0.16 |
| C18:0 10-methyl | 0.24 | ND | 0.42 |
| C19:0 anteiso | 0.57 | 0.18 | ND |
| C19:0 cyclo w8c | 0.15 | 0.09 | 0.22 |
| C19:0 | ND | ND | 0.12 |
| C20:4 w6, 9, 12, 15c | ND | ND | 0.20 |
| C20:0 | 0.49 | ND | 0.38 |

The relative contents of the Gram-negative bacteria obtained by the method of the invention and by the PLFA-based chromatogram analysis are statistically analyzed, and the relative contents of the Gram-negative bacteria obtained by the two methods and the linear relation thereof were shown in Table 3. It was known from the data in the table that the linear relation between the relative content of the Gram-negative bacterial analyzed by the two method was relative good, R²=0.95, which further demonstrated the advantages of the method applied in the Gram-negative bacteria.

TABLE 3
Analysis results of two methods

| Sample | KDO/MLSS | PLFA | Linear relation |
|---|---|---|---|
| A | 0.56 | 10.2% | Y = 0.0709 X + 0.0541 |
| B | 0.18 | 6.3% | R² = 0.95 |
| C | 1.13 | 13.1% | |

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A method for measuring a relative content of Gram-negative bacteria in an active sludge, the method comprising:
1) breaking zoogloeas in the active sludge;
2) isolating 2-keto-3-deoxyoctonic acid (KDO) from free bacteria and cell debris;
3) performing fluorescence labeling on the isolated KDO whereby obtaining a fluorescent derivative; and
4) isolating the fluorescent derivative by high performance liquid chromatography (HPLC) and conducting quantitative measurement by fluorescence, whereby obtaining the relative content of the Gram-negative bacteria in the active sludge.

2. The method of claim 1, wherein in 1), the zoogloeas or the free bacteria are broken into the cell debris.

3. The method of claim 2, wherein in 2), a strong acid is added to the broken sludge and a resulting mixture is heated in a water bath.

4. The method of claim 1, wherein in 3), the isolated KDO is performed with the fluorescence labeling by 4,5-methylenedioxy-1,2-phenylenediamine dihydrochloride (MDB) solution to obtain the fluorescent derivative.

5. The method of claim 2, wherein in 3), the isolated KDO is performed with the fluorescence labeling by 4,5-methylenedioxy-1,2-phenylenediamine dihydrochloride (MDB) solution to obtain the fluorescent derivative.

6. The method of claim 3, wherein in 3), the isolated KDO is performed with the fluorescence labeling by 4,5-methylenedioxy-1,2-phenylenediamine dihydrochloride (MDB) solution to obtain the fluorescent derivative.

7. The method of claim 1, wherein the relative content of the Gram-negative bacteria is calculated by the following equation:
$$Relative content of Gram - negative bacteria ( µg \text{/} mg ) = \frac{KDO ( µg \text{/} L )}{MLSS ( mg \text{/} L )}$$
in which, KDO represents the content of 2-keto-3-deoxyoctonic acid in different sludge samples measured by the HPLC, and MLSS represents a content of mixed liquor suspended solids.

8. The method of claim 2, wherein the relative content of the Gram-negative bacteria is calculated by the following equation:
$$Relative content of Gram - negative bacteria ( µg \text{/} mg ) = \frac{KDO ( µg \text{/} L )}{MLSS ( mg \text{/} L )}$$
in which, KDO represents the content of 2-keto-3-deoxyoctonic acid in different sludge samples measured by the HPLC, and MLSS represents a content of mixed liquor suspended solids.

9. The method of claim 3, wherein the relative content of the Gram-negative bacteria is calculated by the following equation:
$$Relative content of Gram - negative bacteria ( µg \text{/} mg ) = \frac{KDO ( µg \text{/} L )}{MLSS ( mg \text{/} L )}$$
in which, KDO represents the content of 2-keto-3-deoxyoctonic acid in different sludge samples measured by the HPLC, and MLSS represents a content of mixed liquor suspended solids.
